(19) United States
(12) Patent Application Publication
(10) Pub. No.: US 2017/0038643 A1
(43) Pub. Date: Feb. 9, 2017

(54) DISPLAY PANEL AND MANUFACTURING METHOD THEREOF

(71) Applicant: Au Optronics Corporation, Hsinchu (TW)

(72) Inventors: Pu-Jung Huang, New Taipei City (TW); Cheng-Yeh Tsai, Taipei City (TW); Kohei Goto, Chiba (JP); Daniel Antonio Sahade, Chiba (JP)

(21) Appl. No.: 15/086,077

(22) Filed: Mar. 31, 2016

(30) Foreign Application Priority Data
Aug. 6, 2015 (TW) 104125614

(51) Int. Cl. G02F 1/1337; G02F 1/1343; C09K 19/56; G02F 1/1341

(52) U.S. Cl. CPC G02F 1/133711; G02F 1/1341; G02F 1/13439; G02F 1/133723; G02F 1/133788; C09K 19/56

(57) ABSTRACT

A manufacturing method of a display panel includes following steps. A pixel array substrate and an opposite substrate are provided. An interface layer is formed on the pixel array substrate or on the opposite substrate, and the interface layer includes at least one dianhydride compound, a polyimide precursor obtained by subjecting at least one diamine compound to a reaction, and a polyimide compound obtained by subjecting the polyimide precursor to imidization. The polyimide compound includes at least one diamine compound having a photo-reactive side chain.

### CROSS-REFERENCE TO RELATED APPLICATION

This application claims the priority benefit of Taiwan application serial no. 104125614, filed on Aug. 6, 2015. The entirety of the above-mentioned patent application is hereby incorporated by reference herein and made a part of this specification.

### FIELD OF DISCLOSURE

The disclosure relates to a display panel and a manufacturing method thereof; more particularly, the disclosure relates to a liquid crystal display (LCD) panel and a manufacturing method thereof.

### DESCRIPTION OF RELATED ART

In 1888 A.D., Friedrich Reinitzer placed a cholesteric benzoate in a polarizing microscope and observed that the cholesteric benzoate appears in different colors (blue-violet and blue) as in an isotropic phase and in a cholesteric phase, and a color variation phenomenon between the isotropic and cholesteric phases only exists within a very small temperature range (about a temperature range of 1° C. (centigrade degree)). In 1970 A.D., many scientists confirmed the above-mentioned phenomenon is a new thermodynamically stable phase through conducting volumetric analysis, using high resolution differential scanning calorimetry, and so forth. Said phenomenon is called as blue phase (BP).

Normal liquid crystal is optically anisotropic; by contrast, the BP liquid crystal is optically isotropic. In other words, the BP liquid crystal has a very low birefringence or does not even have a birefringence. Since the periodic lattice of the BP is a function of a visible light wavelength, a selective bragg reflection may occur. This feature enables the BP liquid crystal to be applied to the use of fast light modulators. However, no matter in terms of a theoretical prediction or an experimental observation, the BP liquid crystal merely appears in molecular materials possessing high purity and high chirality, causing the BP liquid crystal to merely exist within a very small temperature range. Therefore, the BP liquid crystal is often discussed in an academic field, whereas the practical application of the BP liquid crystal is rather difficult.

In the last decade, in order to enable the display quality of the liquid crystal display (LCD) panel to override the display quality of the cathode ray tube display, the BP liquid crystal featuring a rapid response speed again receives the attention from the academic world and the industry. To meet application demands, the BP liquid crystal is required to possess a wide temperature application range; and therefore different techniques have been proposed. For instance, a feature of stability of polymer (i.e. formation of a reticular polymer structure) is utilized to generate the BP that can exist within a wide range of temperature (see Nature materials, 2002, 1, 64). In addition, in 2002 A.D., Kikuchi et al. successfully produced the BP liquid crystal characterized by a temperature range of approximately 60° C. (centigrade degree) and a stable, gel-like structure. Although the BP liquid crystal has the advantages of short response time and optical isotropy, it has the disadvantage of the relatively high driving voltage, which can reach up to 55 volts. From the viewpoint of mass production, the high driving voltage of the BP liquid crystal is one of the problems demanding solutions.

### SUMMARY

The disclosure is directed to a display panel and a manufacturing method thereof for reducing a driving voltage required for driving a liquid crystal display (LCD) panel.

In an embodiment of the disclosure, a manufacturing method of a display panel includes following steps. A pixel array substrate and an opposite substrate are provided. An interface layer is formed on the pixel array substrate or the opposite substrate, and the interface layer includes at least one dianhydride compound, a polyimide precursor obtained by subjecting at least one diamine compound to a reaction, and a polyimide compound obtained by subjecting the polyimide precursor to imidization. The polyimide compound includes at least one structure originated from a diamine compound having a photo-reactive side chain.

In another embodiment of the disclosure, a display panel that includes a pixel array substrate, an opposite substrate, an interface layer, a first polymer layer, a second polymer layer, and a liquid crystal layer is provided. The pixel array substrate has a pixel array. The opposite substrate is located opposite to the pixel array substrate. The interface layer is located on a surface of the pixel array substrate or a surface of the opposite substrate. Here, the interface layer is at least one dianhydride compound, a polyimide precursor obtained by subjecting at least one diamine compound to a reaction, and a film layer formed by polymerizing a polyimide compound obtained by subjecting the polyimide precursor to imidization. The polyimide compound includes at least one structure originated from a diamine compound having a photo-reactive side chain. The first polymer layer is located on a surface of the interface layer. The second polymer layer is located on a surface of one of the pixel array substrate and the opposite substrate opposite to the other substrate where the first polymer layer is located, and compositions of the first polymer layer are the same as compositions of the second polymer layer. The liquid crystal layer is located between the pixel array substrate and the opposite substrate, and arrangement of the liquid crystal layer is subjected to reactions of the first polymer layer and the second polymer layer.

In view of the above, the interface layer having certain compositions is formed by applying the manufacturing method of the display panel provided herein. As long as the display panel is formed by performing said manufacturing method, the resultant display panel not only can have the advantages of BP liquid crystal (e.g., short response time and optical isotropy) but also can be driven by a relatively low driving voltage.

In order to make the aforementioned features and advantages of the disclosure more comprehensible, embodiments accompanied with figures are described in detail below.

### BRIEF DESCRIPTION OF THE DRAWINGS

FIG. 1 is a cross-sectional diagram illustrating a portion of a display panel before an irradiation process is performed according to an embodiment of the disclosure.

FIG. 2 is a cross-sectional diagram illustrating a portion of a display panel after an irradiation process is performed according to an embodiment of the disclosure.

FIG. 3 is a cross-sectional diagram illustrating a portion of a display panel after an irradiation process is performed according to another embodiment of the disclosure.

FIG. 4 is a schematic partial circuit diagram illustrating a pixel array of a display panel according to an embodiment of the disclosure.

FIG. 5 is a diagram showing a correlation between transmittance of a display panel and a driving voltage according to an embodiment shown in FIG. 2 and a correlation between transmittance of a display panel and a driving voltage according to a comparative example.

FIG. 6 is a diagram showing a correlation between transmittance of a display panel and a driving voltage according to an embodiment shown in FIG. 3 and a correlation between transmittance of a display panel and a driving voltage according to a comparative example.

FIG. 7 is a cross-sectional diagram of LC cell using both side coated substrates by the interface layer.

FIG. 8 is a diagram showing a correlation between transmittance of a display panel and a driving voltage according to an embodiment shown in FIG. 7 and a correlation between transmittance of a display panel and a driving voltage according to an embodiment shown in FIG. 2 as a comparative reference.

FIG. 9 shows the cross-sectional diagram of LC cell fabricated by a non-coated array substrate and a coated opposite substrate by a rubbed interface layer.

### DETAILED DESCRIPTION OF DISCLOSED EMBODIMENTS

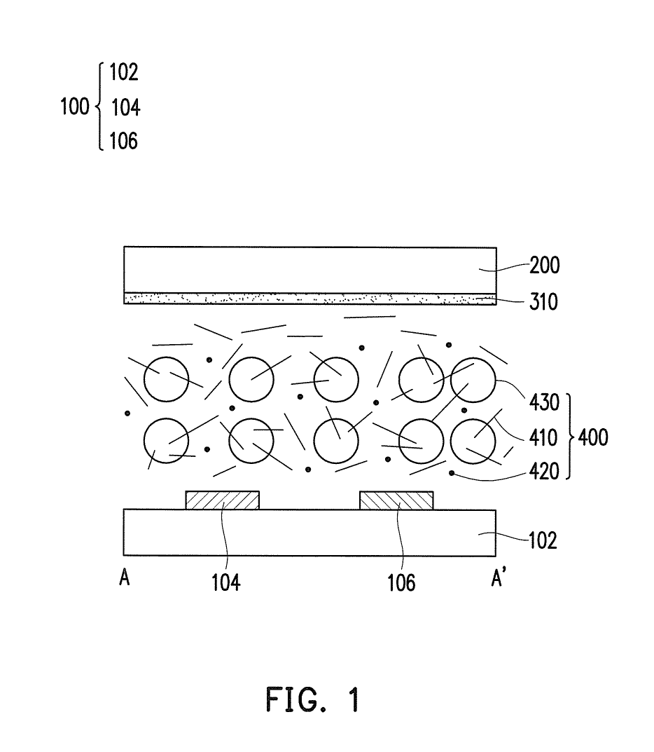

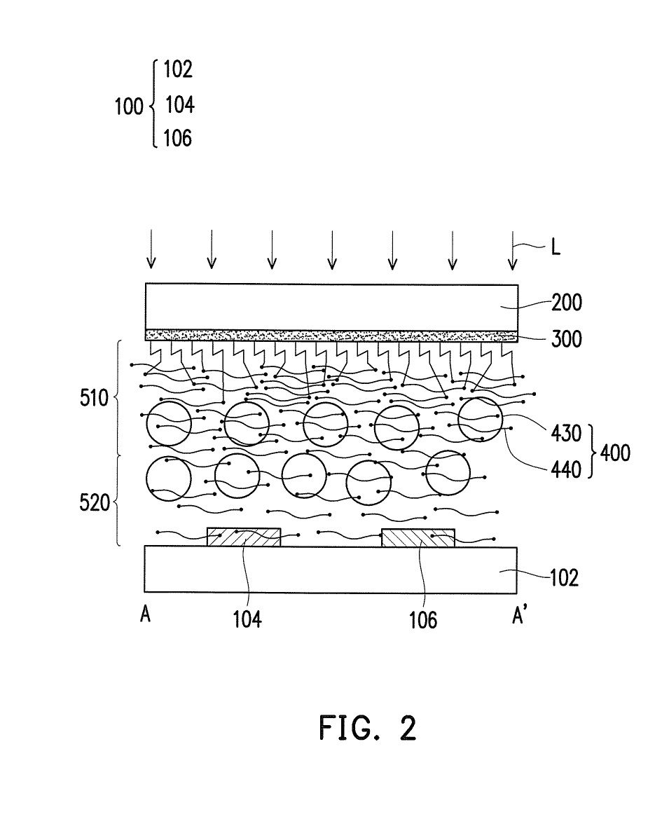

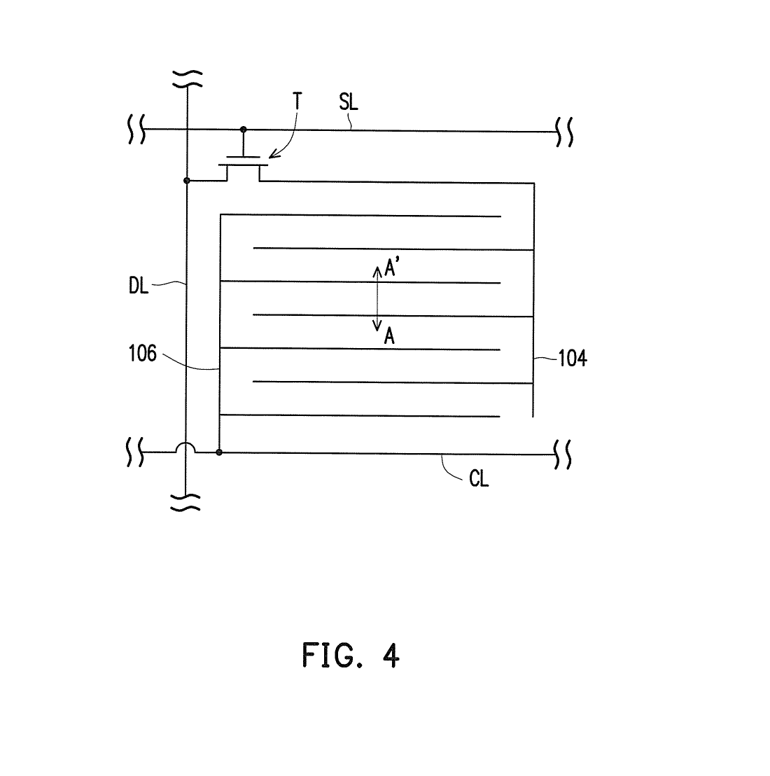

FIG. 4 is a schematic partial circuit diagram illustrating a pixel array of a display panel according to an embodiment of the disclosure. FIG. 1 is a cross-sectional diagram illustrating a portion of a display panel before an irradiation process is performed according to an embodiment of the disclosure. Here, FIG. 1 corresponds to the AA′ cross-sectional diagram in FIG. 4. FIG. 2 is a cross-sectional diagram illustrating a portion of a display panel after an irradiation process is performed according to an embodiment of the disclosure. Here, FIG. 2 corresponds to the cross-sectional diagram taken along AA′ in FIG. 4.

With reference to FIG. 1, the display panel includes a pixel array substrate 100, an opposite substrate 200, and a liquid crystal material composition 400. The pixel array substrate 100 includes a first substrate 102 and a pixel array (not shown) arranged on the first substrate 102, as shown in FIG. 4. FIG. 4 merely illustrates one of the data lines DL, one of the scan lines SL, one of the common electrode lines CL, and one of the pixel structures (including an active device T, a pixel electrode 104, and a common electrode 106). A first terminal (the gate) of the active device T is connected to the scan line SL, and a second terminal (the source) of the active device T is connected to the data line DL. A third terminal (the drain) of the active device T is electrically connected to the pixel electrode 104. Here, the active device T may serve as a switch device for providing voltage information into the pixel electrode 104 and may be a bottom-gate thin film transistor or a top-gate thin film transistor. The common electrode 106 is electrically connected to the common electrode line CL, and a common voltage (not shown), for instance, is applied to the common electrode 106. When the active device T is turned on to write the voltage information into the pixel electrode 104, a first voltage (not shown) is applied to the pixel electrode 104, and a value of the first voltage is different from a value of the voltage of the common electrode line CL, such that there is a difference between the voltage of the pixel electrode 104 and the voltage of the common electrode 106. At this time, a lateral electric field is generated between the pixel electrode 104 and the common electrode 106, so as to drive the display medium.

With reference to FIG. 1, an interface layer 310 is formed on an opposite substrate 200. The interface layer 310 includes at least one dianhydride compound, a polyimide precursor obtained by subjecting at least one structure originated from a diamine compound to a reaction, and a polyimide compound obtained by subjecting the polyimide precursor to imidization. The polyimide compound includes at least one diamine compound having a photo-reactive side chain.

Specifically, in the present embodiment, the at least one diamine compound having the photo-reactive side chain is expressed by formula (1):

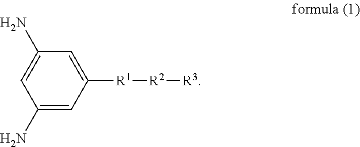

Here, R¹ represents —CH₂—, —O—, —COO—, —NHCO—, —NH—, —CH₂O—, —N(CH₃)—, —CON(CH₃)—, or —N(CH₃)CO—; R² represents a cyclic C₁-C₂₀ alkylene group, an unsubstituted C₁-C₂₀ alkylene group, a C₁-C₂₀ alkylene group substituted with fluorine atoms, an unsubstituted C₁-C₃ alkyl group, a C₁-C₃ alkyl group substituted with fluorine atoms, or a benzene ring obtained through substitution of the C₁-C₃ alkyl group. If the substituted groups are not adjacent to each other, any —CH₂— of the C₁-C₂₀ alkylene group can be replaced by —O—, —COO—, —NHCO—, —NH—, —NHCONH—, —NHCOO—, or —OOCNH—. Besides, R³ represents an acryl group or a methacrylic group or cinnamoyl derivative or maleimide group. In these groups, preferably R³ represents an acryl group or a methacrylic group.

Preferably, the diamine compound having the photo-reactive side chain is one of the following, for instance:

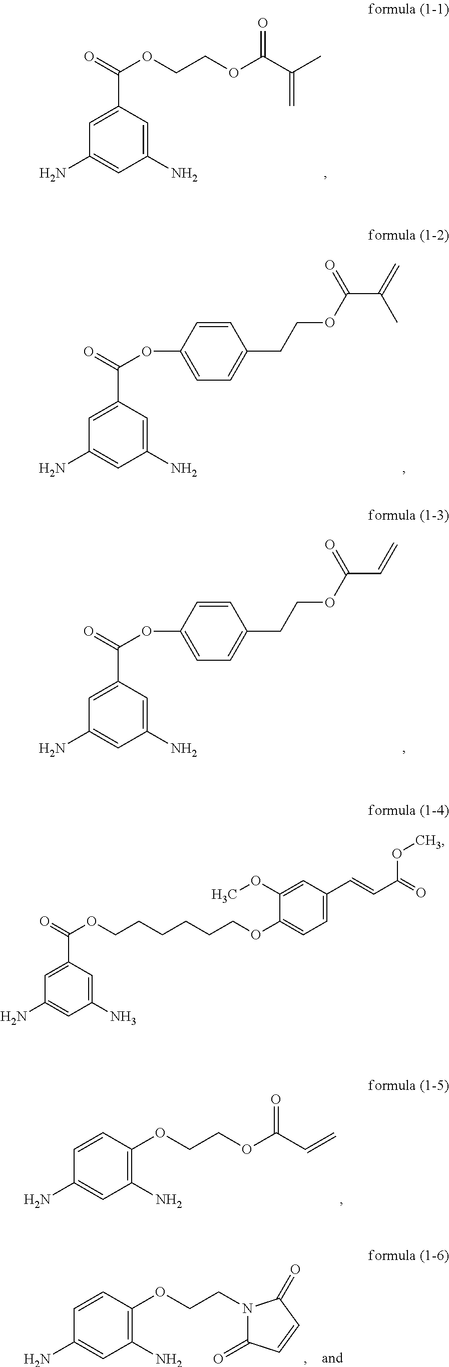 [SMILES: C=C(C)C(=O)OCCOC(=O)c1cc(N)cc(N)c1 ; C=C(C)C(=O)OCCc1ccc(OC(=O)c2cc(N)cc(N)c2)cc1 ; C=CC(=O)OCCc1ccc(OC(=O)c2cc(N)cc(N)c2)cc1 ; COC(=O)/C=C/c1ccc(OCCCCCCOC(=O)c2cc(N)cc(N)c2)c(OC)c1 ; C=CC(=O)OCCOc1ccc(N)cc1N ; Nc1ccc(OCCN2C(=O)C=CC2=O)c(N)c1]

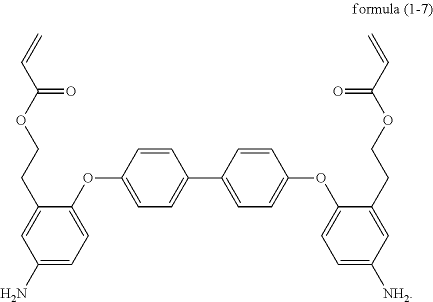 [SMILES: C=CC(=O)OCCc1cc(N)ccc1Oc1ccc(-c2ccc(Oc3ccc(N)cc3CCOC(=O)C=C)cc2)cc1]

If the normal diamine compound does not pose any negative impact on the effects achieved herein, not only the diamine compound having the photo-reactive side chain but also the normal diamine compound may serve as one of the diamine compounds discussed herein. The normal diamine compound is not specifically limited in the disclosure. In the present embodiment, the at least one diamine compound not only includes the diamine compound having the photo-reactive side chain but also includes the diamine compound expressed by formula (2) below. Here, the diamine compound having the photo-reactive side chain accounts for approximately 1-50 mol % of the total sum of the at least one diamine compound. Preferable ratio of the diamine compound having the photo-reactive side chain accounts for approximately 1-15 mol % of the total sum of the at least one diamine compound and most preferable ratio of the diamine compound having the photo-reactive side chain accounts for approximately 1-10 mol % of the total sum of the at least one diamine compound.

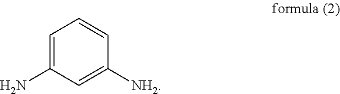

The at least one dianhydride compound is not specifically limited in the disclosure. In the present embodiment, the at least one dianhydride compound includes following compounds, for instance,

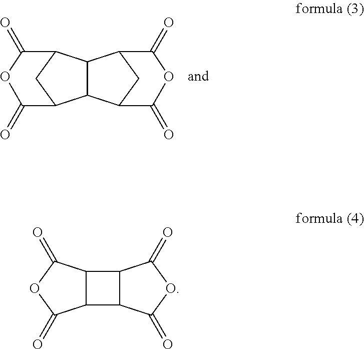 [SMILES: O=C1OC(=O)C2CC1C1C3CC(C(=O)OC3=O)C21 ; O=C1OC(=O)C2C1C1C(=O)OC(=O)C21]

According to an embodiment of the disclosure, the at least one dianhydride compound may simultaneously includes the compound expressed by the formula (3) and the compound expressed by the formula (4), and a ratio of the compound expressed by the formula (3) to the compound expressed by the formula (4) is 1:1, for instance.

For clarification, a polymerization reaction of the at least one diamine compound and the at least one dianhydride is further elaborated below. The reactive material applied in the polymerization reaction includes the normal diamine compound expressed by the formula (2), the diamine compound having a photo-reactive side chain as expressed by the formula (1-1), the dianhydride compound expressed by the formula (3), and the dianhydride compound expressed by the formula (4). After the diamine compound and the dianhydride compound are mixed, the resultant polymerization reaction is shown below, for instance, which should however not be construed as limitations in the disclosure:

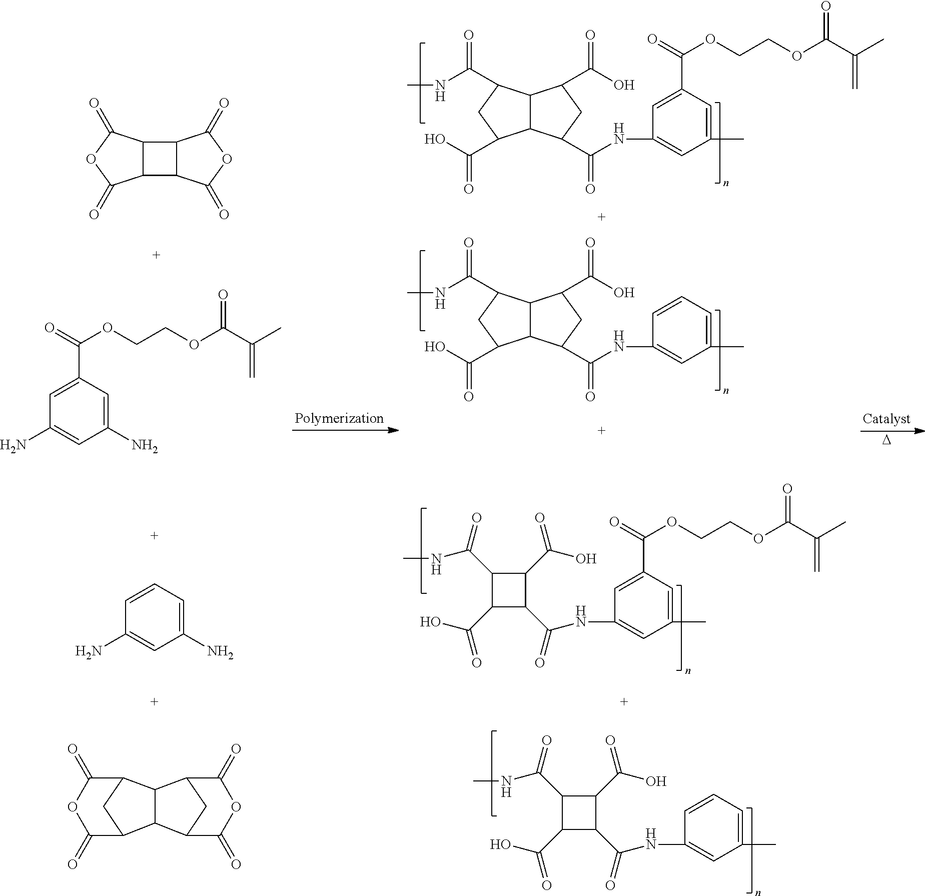

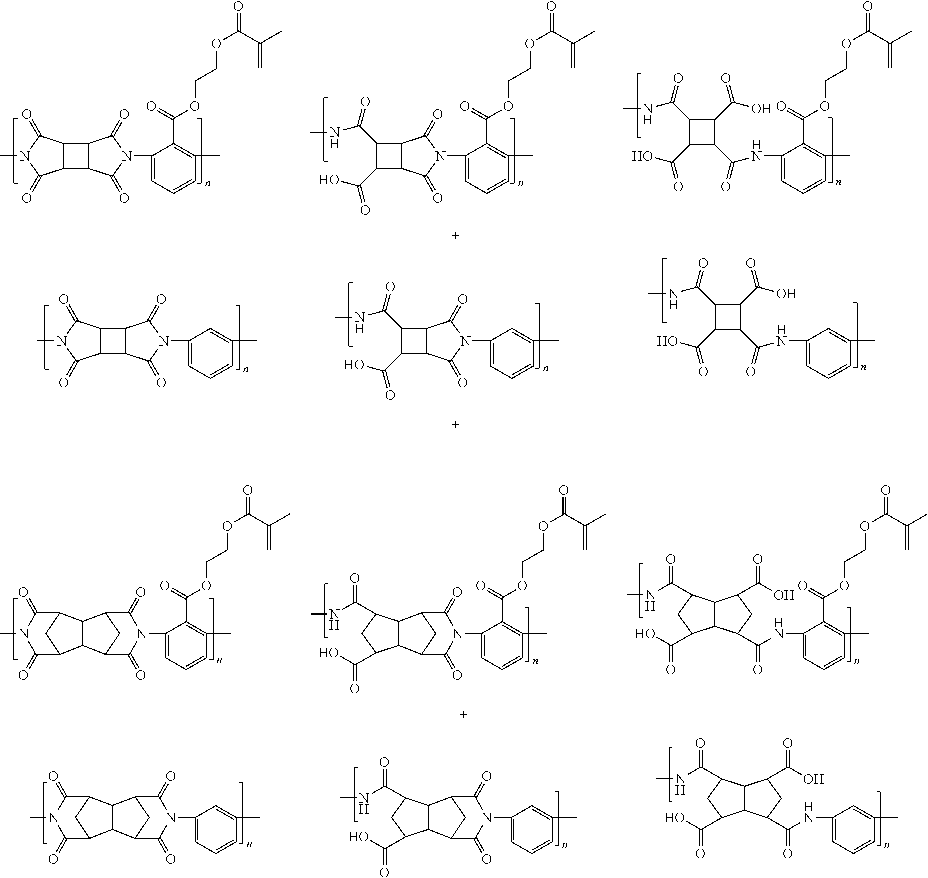

In the present embodiment, the at least one diamine compound accounts for 50 mol % of a total sum of the interface layer 310, and the at least one dianhydride compound accounts for 50 mol % of the total sum of the interface layer 310. Table 1 lists possible ratios of the at least one diamine compound to the at least one dianhydride compound, which should however not be construed as limitations in the disclosure.

TABLE 1

| | | |
|---|---|---|
| at least one diamine compound | 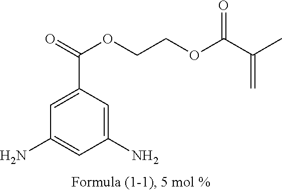 [SMILES: C=C(C)C(=O)OCCOC(=O)c1cc(N)cc(N)c1] | 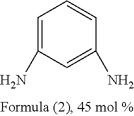 |
| at least one dianhydride compound | 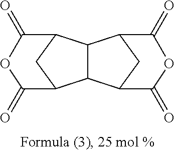 [SMILES: O=C1OC(=O)C2CC1C1C3CC(C(=O)OC3=O)C21] | 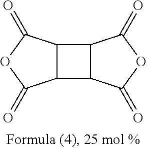 [SMILES: O=C1OC(=O)C2C1C1C(=O)OC(=O)C21] |

A method of forming the interface layer 310 includes: coating a surface of the opposite substrate 200 with the reactive material having the at least one diamine compound and the at least one dianhydride compound through roll coating, spin coating, printing, ink-jet printing, and so forth, so as to form a pre-coating layer (not shown); performing pre-bake treatment and post-bake treatment on the pre-coating layer to form the interface layer 310. However, the disclosure should not be limited to the embodiment provided herein.

The pixel array substrate 100 and the opposite substrate 200 are assembled to each other, and the liquid crystal material composition 400 is injected into a space between the pixel array substrate 100 and the opposite substrate 200. The liquid crystal material composition 400 includes a reactive monomer 410 and a liquid crystal material 430. According to the present embodiment, the reactive monomer 410 of the liquid crystal material composition 400 includes one of the following:

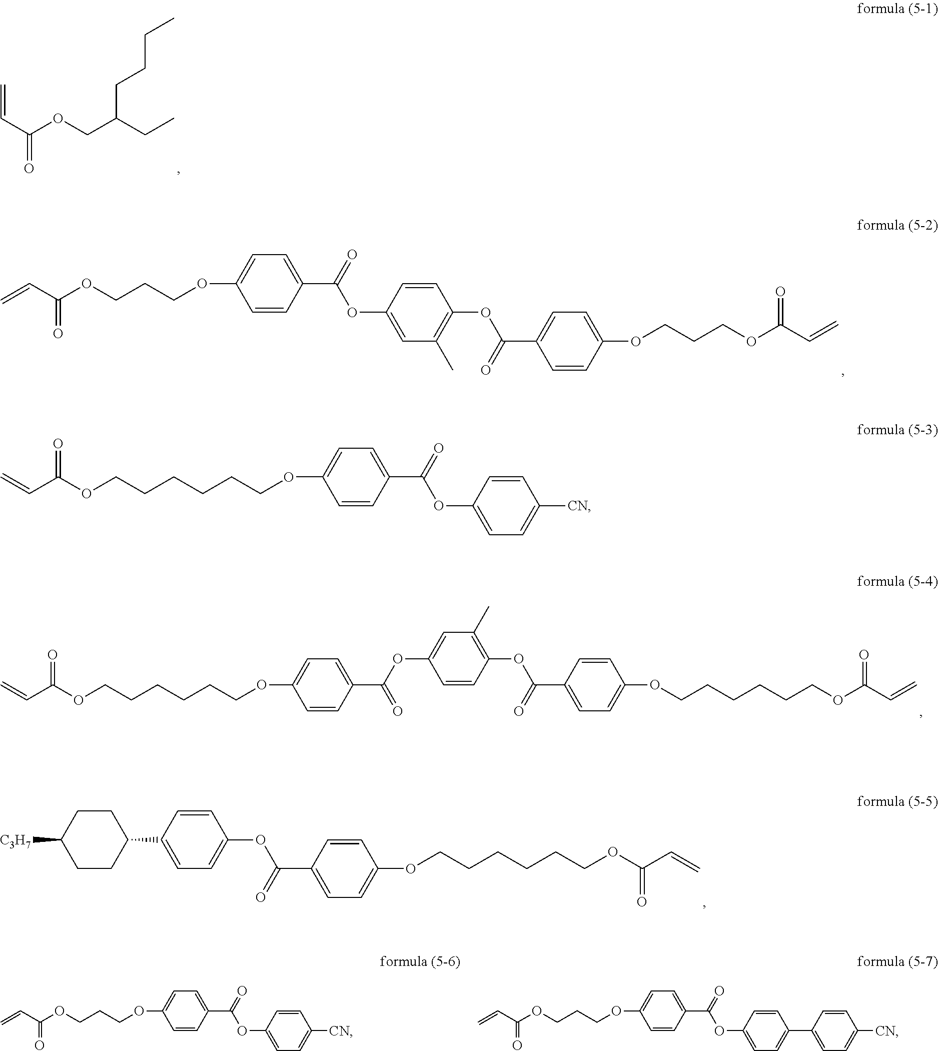

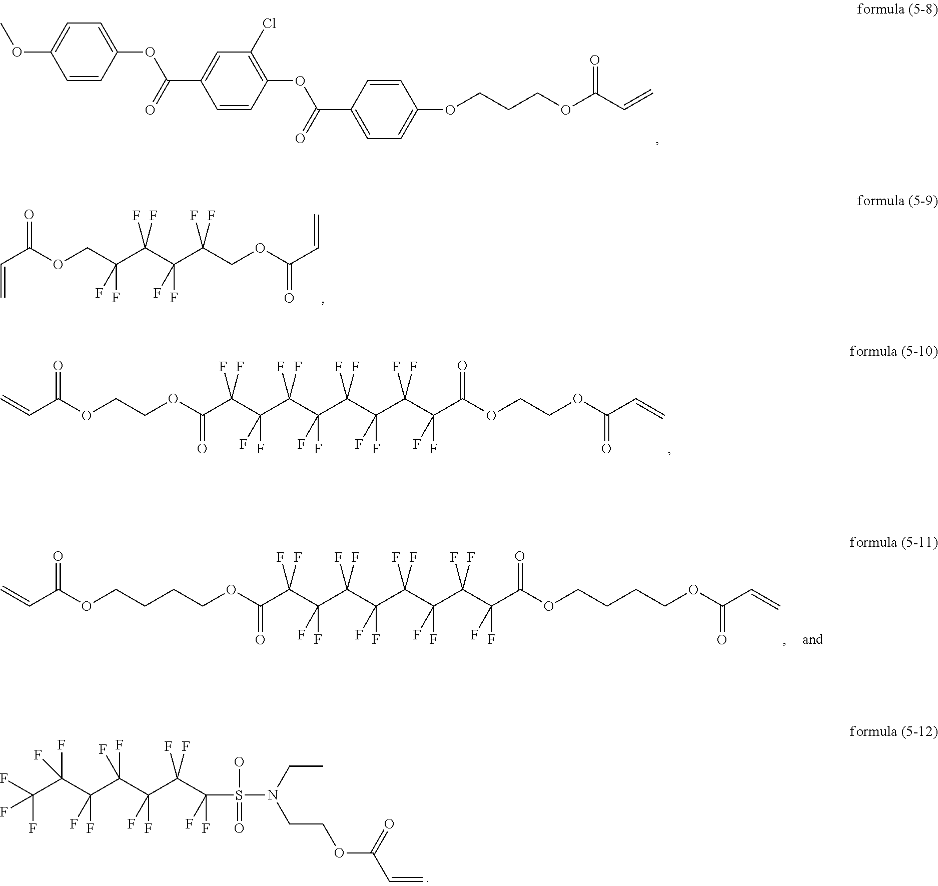

According to the present embodiment, the liquid crystal material 430 of the liquid crystal material composition 400 is a blue phase (BP) liquid crystal material, for instance. The liquid crystal material composition 400 may further include a photo-initiator 420 that is 2,2-dimethoxy-1,2-diphenyl-ethanone (DMPAP), for instance; however, the disclosure is not limited thereto.

With reference to FIG. 2, an irradiation process L is performed on one side of the opposite substrate 200, such that the interface layer 310 and the liquid crystal material composition 400 are polymerized to form at least one polymer layer. Specifically, the interface layer 310 becomes the interface layer 300 after the irradiation process L is performed; simultaneously, both the diamine compound having a photo-reactive side chain in the interface layer 310 and the reactive monomer 410 in the liquid crystal material composition 400 participate in the polymerization reaction resulting from the irradiation process L. The photo-initiator 420 is beneficial for promoting the polymerization reaction, so as to form a polymer 440 and further form a first polymer layer 510 and a second polymer layer 520. The display panel with the structure as shown in FIG. 2 is then obtained. Here, a density of the first polymer layer 510 is greater than a density of the second polymer layer 520. In the present embodiment, the irradiation process L is performed by UV light, for instance; conditions on which the irradiation process L is performed may be: UV light intensity: 2 mW/cm², irradiation time: 240 seconds, total energy: 480 mJ. Up to this point, the display panel is completely formed.

With respect to the structure of the display panel, as shown in FIG. 2, the display panel includes the pixel array substrate 100, the opposite substrate 200, the interface layer 300, the first polymer layer 510, the second polymer layer 520, and the liquid crystal layer 400. The pixel array substrate 100 has the pixel array (not shown). The opposite substrate 200 is located opposite to the pixel array substrate 100. The interface layer 300 is located on the opposite substrate 200, and the interface layer 300 is at least one dianhydride compound, a polyimide precursor obtained by subjecting at least one diamine compound to a reaction, and a film layer formed by polymerizing a polyimide compound obtained by subjecting the polyimide precursor to imidization. The second polymer layer 520 is located on the surface of the pixel array of the pixel array substrate 100. The compositions of the first polymer layer 510 are the same as the compositions of the second polymer layer 520. Specifically, the compositions of the first and second polymer layers 510 and 520 are polymers that are polymerized after the reactive monomer 410 in the liquid crystal material composition 400 is irradiated. The liquid crystal layer 400 is located between the pixel array of the pixel array substrate 100 and the interface layer 300 of the opposite substrate 200, and arrangement of the liquid crystal layer 400 is subjected to reactions of the first polymer layer 510 and the second polymer layer 520. In the present embodiment, the irradiation process L is performed on one side of the opposite substrate 200, and therefore the density of the first polymer layer 510 is greater than the density of the second polymer layer 520.

As provided above, the manufacturing method of the display panel provided herein allows the interface layer with certain compositions to be formed in the display panel, such that the resultant display panel not only can have the advantages of BP liquid crystal (e.g., short response time and optical isotropy) but also can be driven by a relatively low driving voltage.

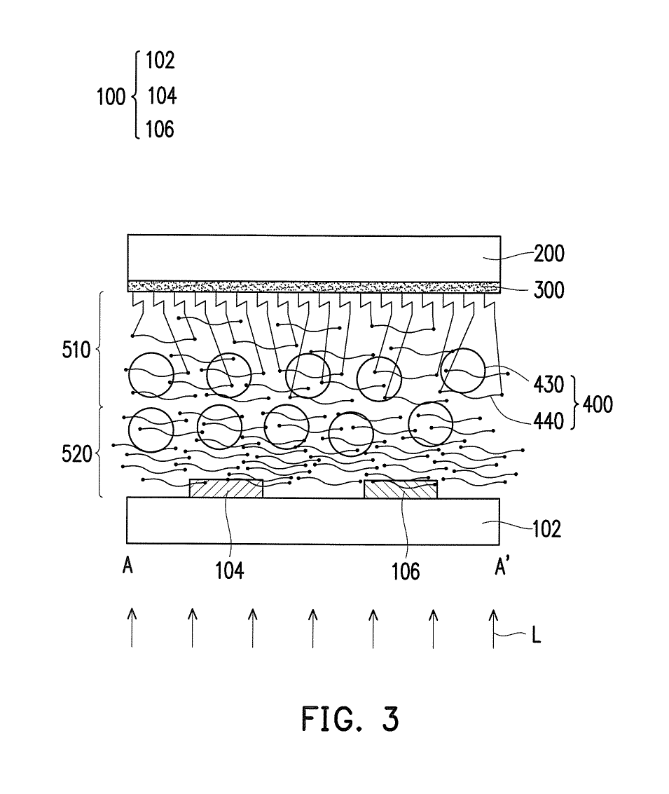

FIG. 3 is a cross-sectional diagram illustrating a portion of a display panel after an irradiation process is performed according to an embodiment of the disclosure. Here, FIG. 3 corresponds to the cross-sectional diagram taken along AA′ in FIG. 4. The manufacturing process provided in the present embodiment is similar to that provided in the previous embodiment; therefore, the same compositions will be marked by identical or similar reference numbers, and the repetitive descriptions will not be further provided hereinafter. The difference between the embodiment shown in FIG. 3 and the embodiment shown in FIG. 2 lies in that the irradiation process L is performed on one side of the pixel array substrate 100, and therefore the density of the second polymer layer 520 is greater than the density of the first polymer layer 510. As shown in FIG. 3, the irradiation process L is performed on one side of the pixel array substrate 100, such that the interface layer 310 and the liquid crystal material composition 400 are polymerized to form at least one polymer layer. Specifically, the interface layer 310 becomes the interface layer 300 after the irradiation process L is performed; simultaneously, both the diamine compound having a photo-reactive side chain in the interface layer 310 and the reactive monomer 410 in the liquid crystal material composition 400 participate in the polymerization reaction resulting from the irradiation process L. The photo-initiator 420 is beneficial for promoting the polymerization reaction of the reactive monomer 410, so as to form a polymer 440 and further form a first polymer layer 510 and a second polymer layer 520. The display panel with the structure as shown in FIG. 3 is then obtained. Here, the density of the second polymer layer 520 is greater than the density of the first polymer layer 510. Up to this point, the display panel is completely formed.

With respect to the structure of the display panel, as shown in FIG. 3, the display panel includes the pixel array substrate 100, the opposite substrate 200, the interface layer 300, the first polymer layer 510, the second polymer layer 520, and the liquid crystal layer 400. The pixel array substrate 100 has the pixel array (not shown). The opposite substrate 200 is located opposite to the pixel array substrate 100. The interface layer 300 is located on the opposite substrate 200, and the interface layer 300 is at least one dianhydride compound, a polyimide precursor obtained by subjecting at least one diamine compound to a reaction, and a film layer formed by polymerizing a polyimide compound obtained by subjecting the polyimide precursor to imidization. The first polymer layer 510 is located on a surface of the interface layer 300. The second polymer layer 520 is located on the surface of the pixel array of the pixel array substrate 100. The compositions of the first polymer layer 510 are the same as the compositions of the second polymer layer 520. Specifically, the compositions of the first and second polymer layers 510 and 520 are polymers that are polymerized after the reactive monomer 410 in the liquid crystal material composition 400 is irradiated. The liquid crystal layer 400 is located between the pixel array of the pixel array substrate 100 and the interface layer 300 of the opposite substrate 200, and arrangement of the liquid crystal layer 400 is subjected to reactions of the first polymer layer 510 and the second polymer layer 520. In the present embodiment, the irradiation process L is performed on one side of the pixel array substrate 100, and therefore the density of the second polymer layer 520 is greater than the density of the first polymer layer 510.

As provided above, the manufacturing method of the display panel provided herein allows the interface layer with certain compositions to be formed in the display panel, such that the resultant display panel not only can have the advantages of BP liquid crystal (e.g., short response time and optical isotropy) but also can be driven by a relatively low driving voltage. In the previous embodiments, the interface layer is formed on the opposite substrate, which should however not be construed as a limitation in the disclosure; in another embodiment, the interface layer can also be formed on the pixel array substrate.

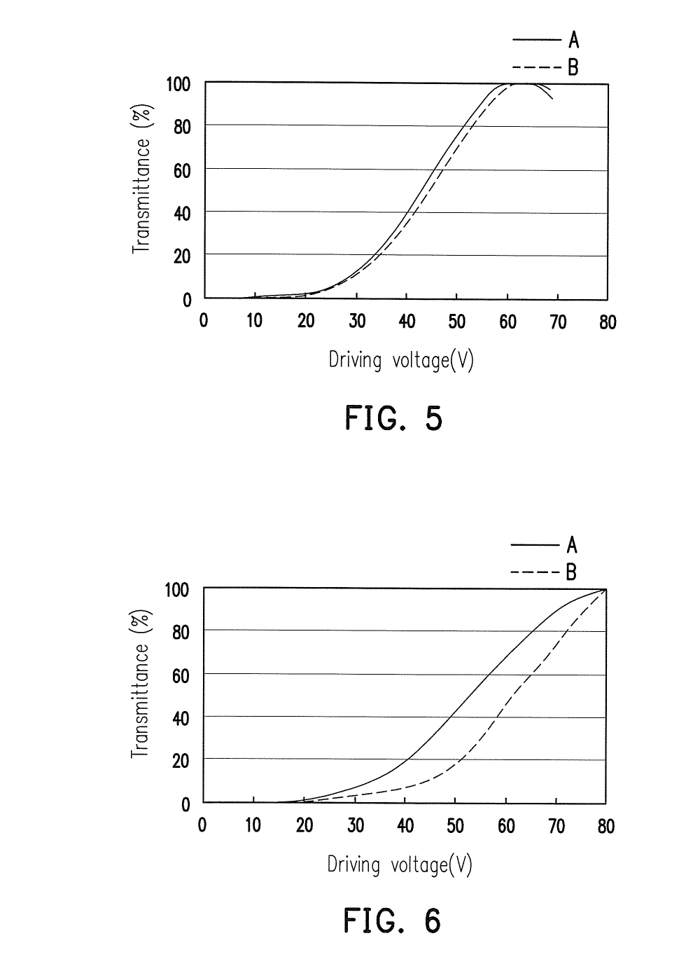

FIG. 5 is a diagram showing a correlation between transmittance of a display panel and a driving voltage according to an embodiment shown in FIG. 2 and a correlation between transmittance of a display panel and a driving voltage according to a comparative example. With reference to FIG. 5, the horizontal axis represents a driving voltage (V), the perpendicular axis represents a transmittance (%), a solid line A is a curve showing the measurement results of the display panel depicted in FIG. 2, and a dotted line B is a curve showing the measurement results of the display panel according to the comparative example. Particularly, in the display panel applied for performing the measurement to obtain the solid line A, the interface layer is formed on the opposite substrate, and the irradiation process is performed on a side of the opposite substrate (as shown in FIG. 2). Here, the compositions of the interface layer and the ratio are listed in Table 1; on the other hand, in the display panel applied for performing the measurement to obtain the dotted line B, no interface layer is formed on the pixel array substrate or on the opposite substrate. If the dotted line B serves as a basis, it can be deduced from FIG. 5 that the solid line A, in comparison with the dotted line B, shows a better transmittance and has the improved photo-electrical properties, given that the same driving voltage is applied. Namely, if the same transmittance is desired, the driving voltage required for obtaining the solid line A is lower than the driving voltage required for obtaining the dotted line B.

FIG. 6 is a diagram showing a correlation between transmittance of a display panel and a driving voltage according to an embodiment shown in FIG. 3 and a correlation between transmittance of a display panel and a driving voltage according to a comparative example. Similar to those in FIG. 5, the horizontal axis in FIG. 6 represents a driving voltage (V), the perpendicular axis in FIG. 6 represents a transmittance (%), a solid line A in FIG. 6 is a curve showing the measurement results of the display panel depicted in FIG. 3, and a dotted line B in FIG. 6 is a curve showing the measurement results of the display panel according to the comparative example. Particularly, in the display panel applied for performing the measurement to obtain the solid line A, the interface layer is formed on the opposite substrate, and the irradiation process is performed on a side of the pixel array substrate (as shown in FIG. 3). Here, the compositions of the interface layer and the ratio are listed in Table 1; on the other hand, in the display panel applied for performing the measurement to obtain the dotted line B, no interface layer is formed on the pixel array substrate or on the opposite substrate. It can be deduced from FIG. 6 that the solid line A, in comparison with the dotted line B, shows a better transmittance, given that the same driving voltage is applied. On the other hand, if the same transmittance is desired, the driving voltage required for obtaining the solid line A is indeed lower than the driving voltage required for obtaining the dotted line B.

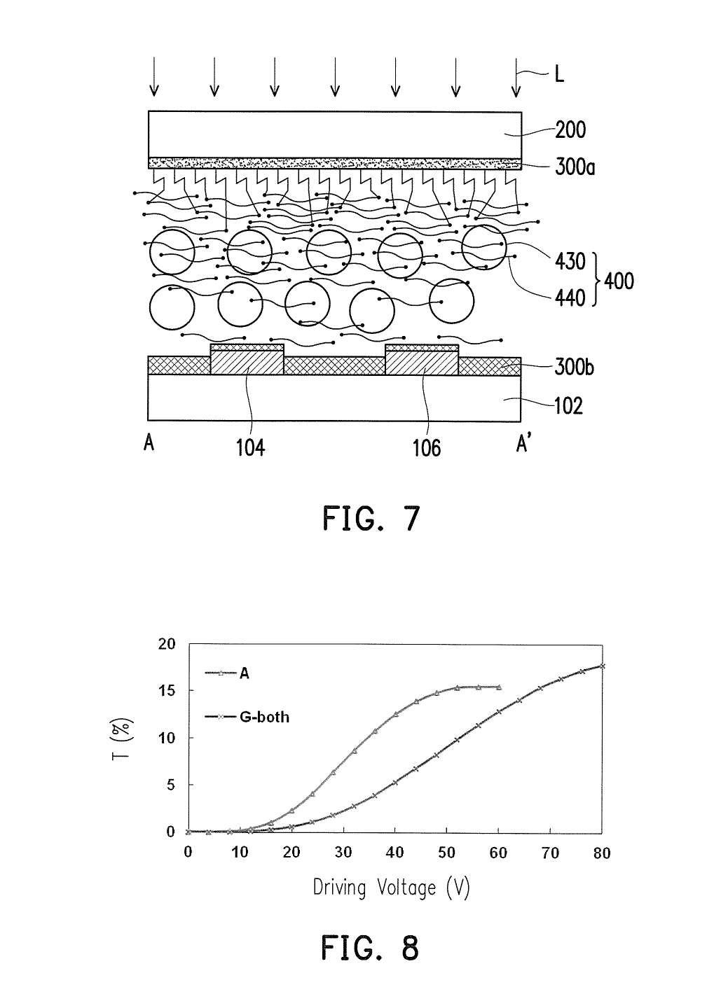

FIG. 7 is a cross-sectional diagram of LC cell using both side coated substrates by the interface layer. That mean both of the array substrate 102 and the opposite substrate 200 are coated by the interface layers 300a, 300b. The difference between the embodiment shown in FIG. 7 and the embodiment shown in FIG. 2 lies in that whether the array substrate 102 is coated by the interface layer or not. FIG. 8 is a diagram showing a correlation between transmittance of a display panel and a driving voltage according to an embodiment shown in FIG. 7 and a correlation between transmittance of a display panel and a driving voltage according to an embodiment shown in FIG. 2 as a comparative reference. Similar to those in FIG. 5, the horizontal axis in FIG. 8 represents a driving voltage (V), the perpendicular axis in FIG. 8 represents a transmittance (%), a line G-both in FIG. 8 is a curve showing the measurement results of the display panel depicted in FIG. 7, and a line A in FIG. 8 is a curve showing the measurement results of the display panel according to an embodiment shown in FIG. 2. It can be deduced from FIG. 8 that the line G-both, in comparison with the line A, shows a worse transmittance, given that the same driving voltage is applied. On the other hand, if the same transmittance is desired, the driving voltage required for obtaining the line G-both is quite higher than the driving voltage required for obtaining the line A.

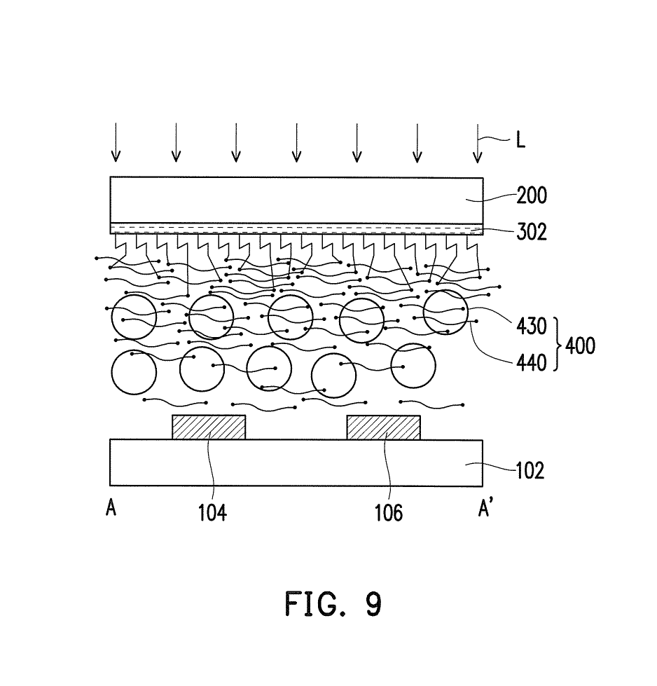

FIG. 9 shows the cross-sectional diagram of LC cell fabricated by a non-coated array substrate 102 and a coated opposite substrate 200 by a rubbed interface layer 302. Rubbing condition of the rubbed interface layer 302 is as follows. Roller rotation speed: 300 rpm, Stage speed: 20 mm/sec., Pile contact length: 0.3 mm. Comparison of black level between the display panel depicted in FIG. 2 and a display panel depicted in FIG. 9 is summarized in Table 2. Black level of the display panel depicted in FIG. 9 becomes poorer compared to the result of the display panel depicted in FIG. 2 because small retardation is generated due to one-directional LC alignment at interface between the interface layer and the LC bulk.

TABLE 2

| Cell configuration | Black level |
|---|---|
| FIG. 2 | Excellent |
| FIG. 9 | Poor |

To sum up, the manufacturing method of the display panel provided herein allows the interface layer with certain compositions to be formed in the display panel, such that the resultant display panel not only can have the advantages of BP liquid crystal (e.g., short response time and optical isotropy) but also can be effectively driven by a reduced driving voltage.

Although the disclosure has been described with reference to the above embodiments, it will be apparent to one of ordinary skill in the art that modifications to the described embodiments may be made without departing from the spirit of the disclosure. Accordingly, the scope of the disclosure will be defined by the attached claims and not by the above detailed descriptions.

What is claimed is:

1. A manufacturing method of a display panel, comprising:
providing a pixel array substrate and an opposite substrate; and
forming an interface layer on the pixel array substrate or the opposite substrate, the interface layer comprising at least one dianhydride compound, a polyimide precursor obtained by subjecting at least one diamine compound to a reaction, and a polyimide compound obtained by subjecting the polyimide precursor to imidization, wherein the polyimide compound includes at least one diamine compound having a photo-reactive side chain.

2. The manufacturing method of claim 1, further comprising:
assembling the pixel array substrate and the opposite substrate and injecting a liquid crystal material composition into a space between the pixel array substrate and the opposite substrate, wherein the liquid crystal material composition includes a liquid crystal material and a reactive monomer; and
performing an irradiation process, such that the interface layer and the liquid crystal material composition are polymerized to form at least one polymer layer.

3. The manufacturing according to claim 1, wherein the at least one diamine compound having the photo-reactive side chain is expressed by formula (1): 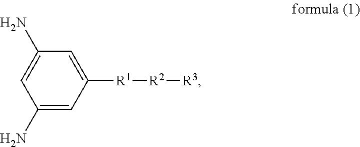
wherein R¹ represents —CH₂—, —O—, —COO—, —NHCO—, —NH—, —CH₂O—, —N(CH₃)—, —CON(CH₃)—, or —N(CH₃)CO—; R² represents a cyclic C₁-C₂₀ alkylene group, an unsubstituted C₁-C₂₀ alkylene group, a C₁-C₂₀ alkylene group substituted with fluorine atoms, an unsubstituted C₁-C₃ alkyl group, a C₁-C₃ alkyl group substituted with fluorine atoms, or a benzene ring obtained through substitution of the C₁-C₃ alkyl group, if the substituted groups are not adjacent to each other, any —CH₂— of the C₁-C₂₀ alkylene group is replaced by —O—, —COO—, —NHCO—, —NH—, —NHCONH—, —NHCOO—, or —OOCNH—, and R³ represents an acryl group or a methacrylic group or cinnamoyl derivative or maleimide group.

4. The manufacturing method of claim 3, wherein the at least one diamine compound equipped with the photo-reactive side chain and expressed by the formula (1) comprises at least one of:

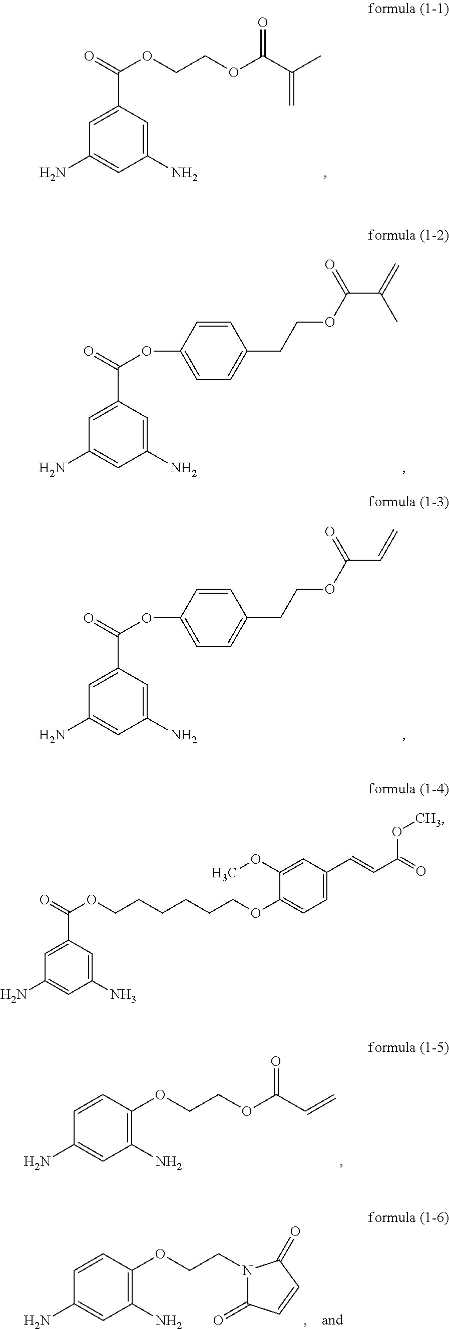 [SMILES: C=C(C)C(=O)OCCOC(=O)c1cc(N)cc(N)c1 ; C=C(C)C(=O)OCCc1ccc(OC(=O)c2cc(N)cc(N)c2)cc1 ; C=CC(=O)OCCc1ccc(OC(=O)c2cc(N)cc(N)c2)cc1 ; COC(=O)/C=C/c1ccc(OCCCCCCOC(=O)c2cc(N)cc(N)c2)c(OC)c1 ; C=CC(=O)OCCOc1ccc(N)cc1N ; Nc1ccc(OCCN2C(=O)C=CC2=O)c(N)c1]

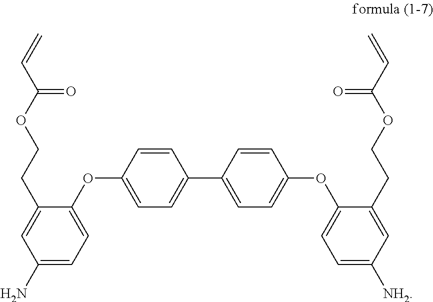 [SMILES: C=CC(=O)OCCc1cc(N)ccc1Oc1ccc(-c2ccc(Oc3ccc(N)cc3CCOC(=O)C=C)cc2)cc1]

5. The manufacturing method of claim 1, wherein the at least one diamine compound accounts for 50 mol % of a total sum of the interface layer, and the at least one dianhydride compound accounts for 50 mol % of the total sum of the interface layer.

6. The manufacturing method of claim 1, wherein the at least one diamine compound further comprises an aromatic diamine compound, and a ratio of the at least one diamine compound having the photo-reactive side chain to the aromatic diamine compound is 1:99-1:1.

7. The manufacturing method of claim 6, wherein the aromatic diamine compound of the at least one diamine compound comprises:

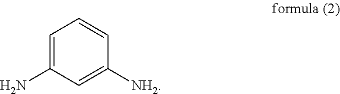

8. The manufacturing method of claim 1, wherein the at least one dianhydride compound comprises compounds respectively expressed by:

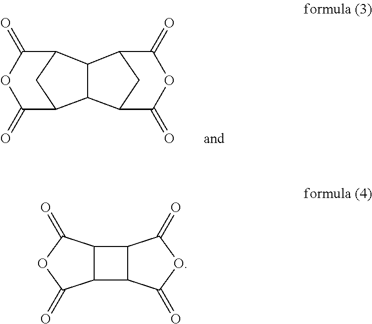 [SMILES: O=C1OC(=O)C2CC1C1C3CC(C(=O)OC3=O)C21 ; "and" ; O=C1OC(=O)C2C1C1C(=O)OC(=O)C21]

9. The manufacturing method of claim 8, wherein the at least one dianhydride compound comprises the compound expressed by the formula (3) and the compound expressed by the formula (4), and a ratio of the compound expressed by the formula (3) to the compound expressed by the formula (4) is 1:1.

10. The manufacturing method of claim 1, wherein the irradiation process is performed on a side of the opposite substrate.

11. The manufacturing method of claim 1, wherein the irradiation process is performed on a side of the pixel array substrate.

12. The manufacturing method of claim 2, wherein the reactive monomer in the liquid crystal material composition comprises one of compounds expressed by:

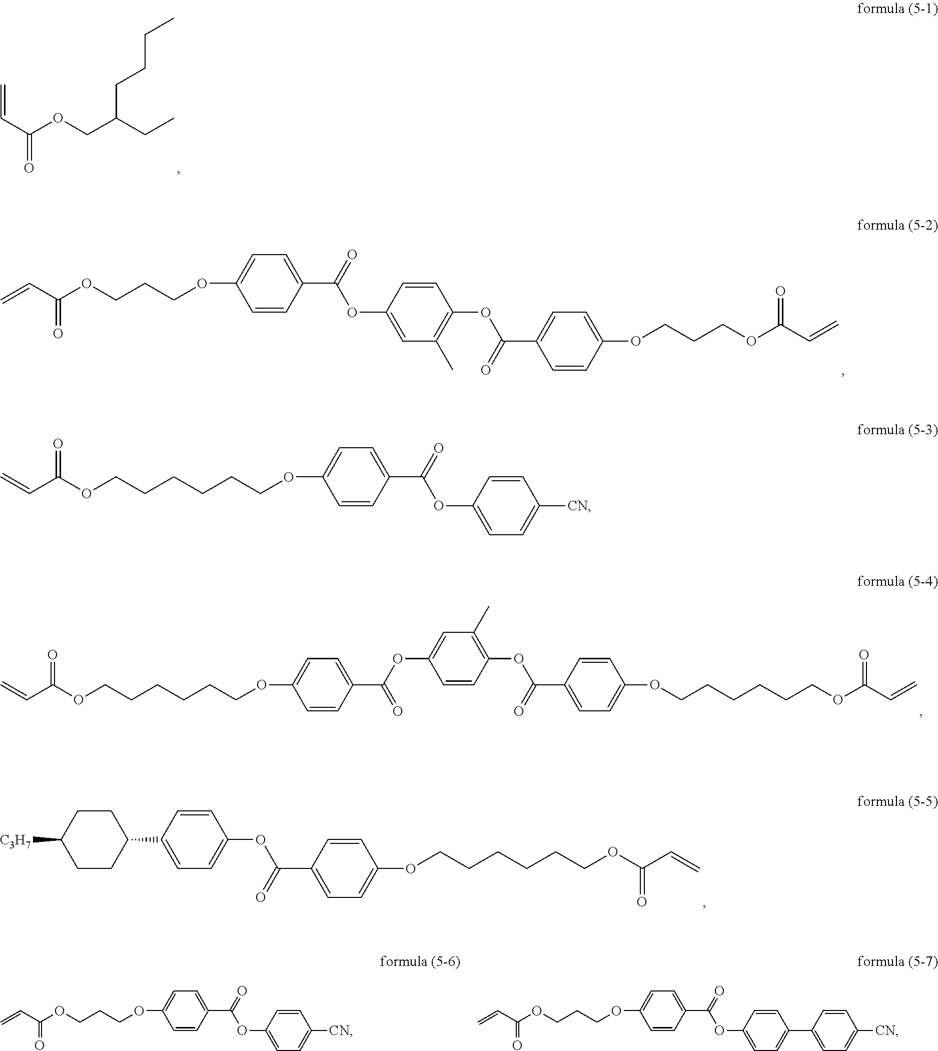

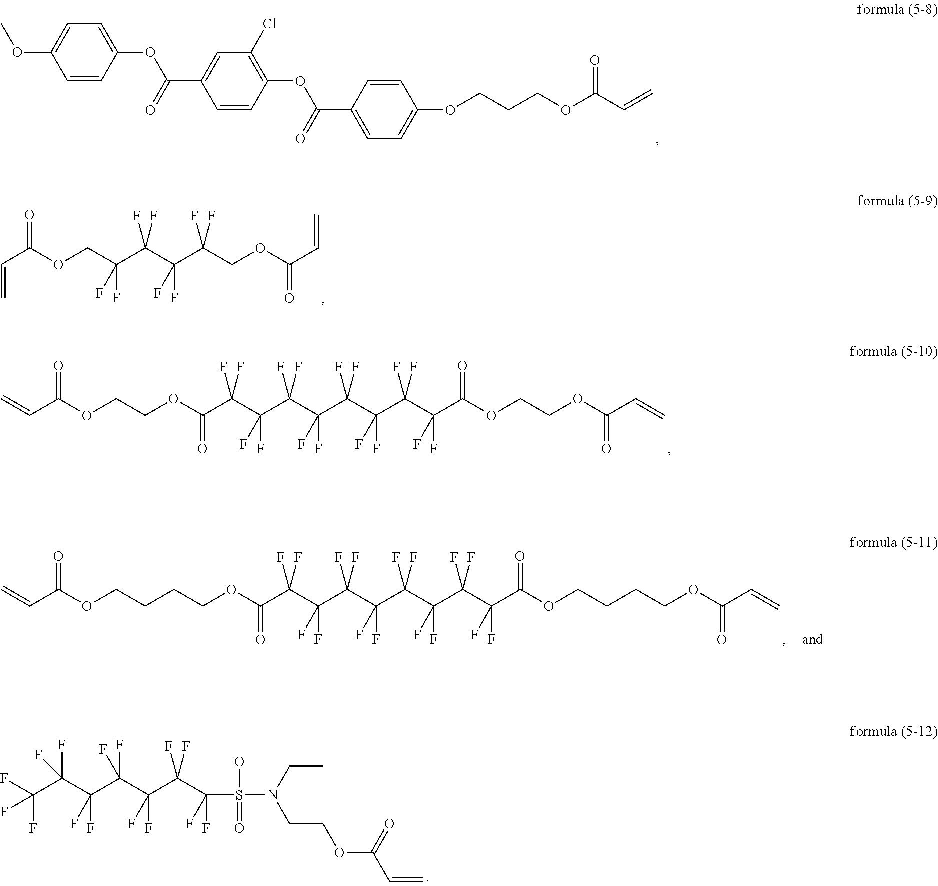

13. The manufacturing method of claim 1, wherein the interface layer is formed on the opposite substrate.

14. The manufacturing method of claim 13, wherein an alignment treatment of the interface layer on the opposite substrate is not performed.

15. A display panel comprising:
a pixel array substrate having a pixel array;
an opposite substrate located opposite to the pixel array substrate;
an interface layer located on a surface of the pixel array substrate or a surface of the opposite substrate, the interface layer being a polyimide precursor obtained by subjecting at least one dianhydride compound and at least one diamine compound to a reaction, and a film layer formed by polymerizing a polyimide compound obtained by subjecting the polyimide precursor to imidization;
a first polymer layer located on a surface of the interface layer; and
a second polymer layer located on a surface of one of the pixel array substrate and the opposite substrate opposite to the other substrate where the first polymer layer is located, wherein compositions of the first polymer layer are the same as compositions of the second polymer layer;
a liquid crystal layer located between the pixel array substrate and the opposite substrate, an arrangement of the liquid crystal layer being subjected to reactions of the first polymer layer and the second polymer layer.

16. The display panel of claim 15, wherein a density of the first polymer layer is greater than a density of the second polymer layer.

17. The display panel of claim 15, wherein a density of the first polymer layer is less than a density of the second polymer layer.
